(19) United States
(12) Patent Application Publication
(10) Pub. No.: US 2026/0023290 A1
(43) Pub. Date: Jan. 22, 2026

(54) DISPLAY SUBSTRATE

(71) Applicants: HEFEI XINSHENG OPTOELECTRONICS TECHNOLOGY CO., LTD., Hefei, Anhui (CN); BOE TECHNOLOGY GROUP CO., LTD., Beijing (CN); BEIJING BOE TECHNOLOGY DEVELOPMENT CO., LTD., Beijing (CN)

(72) Inventors: Mingfei ZHANG, Beijing (CN); Yongcan WANG, Beijing (CN); Quan GAN, Beijing (CN); Yongxian XIE, Beijing (CN); Hui GUO, Beijing (CN)

(73) Assignees: HEFEI XINSHENG OPTOELECTRONICS TECHNOLOGY CO., LTD., Hefei, Anhui (CN); BOE TECHNOLOGY GROUP CO., LTD., Beijing (CN); HEFEI XINSHENG OPTOELECTRONICS TECHNOLOGY CO., LTD., Beijing (CN)

(21) Appl. No.: 18/869,243

(22) PCT Filed: Sep. 28, 2023
(86) PCT No.: PCT/CN2023/122698

§ 371 Date: Nov. 25, 2024

(51) Int. Cl. G02F 1/1362

(52) U.S. Cl. CPC G02F 1/136286; G02F 1/136204

(57) ABSTRACT

A display substrate. The display substrate includes a substrate, and a first electrode, a second electrode, a plurality of first lines and a plurality of second lines arranged on the substrate. The second electrode includes a plurality of second electrode members arranged in an array form, an orthogonal projection of the second electrode onto the substrate is independent of an orthogonal projection of a first wiring region onto the substrate, and an orthogonal projection of the first electrode onto the substrate overlaps with the orthogonal projection of the first wiring region onto the substrate. The first electrode in at least one of the pixel regions has an aperture structure.

### TECHNICAL FIELD

The present disclosure relates to the field of display technology, in particular to a display substrate.

### BACKGROUND

In the related art, the output of small and medium-sized notebooks and vehicle-mounted display screens increases steadily, the technical specifications thereof are gradually stringent, and the demand on in-cell touch gradually increases. In an existing display and display driver integration (TDDI) product, there is a large quantity of source drivers with a relatively high price, so the cost of the TDDI product is high. Based on this, a display substrate in which a pixel electrode is arranged laterally (i.e., an extension direction of the pixel electrode is approximately the same as that of a gate line) is proposed. At this time, the quantity of gate lines is three times that in the existing display product, and the quantity of data lines is ⅓ of that in the existing display product. In this way, in the case that the resolution of the display product remains unchanged, it is able to remarkably reduce the quantity of data lines, thereby to reduce the quantity of source drivers as well as the cost thereof. In addition, a common electrode is separated through providing an appropriate position of a touch signal line and a connection via hole for the touch signal line, and each touch signal line is coupled to a corresponding common electrode block, so as to provide an integrated touch function. However, for a conventional oxide multi-gate structure, in order to achieve the touch function, the common electrode is divided into blocks and an aperture structure is arranged above the gate line. At this time, a fringing electric field is formed between the gate line and the common electrode, so the deflection of liquid crystals and thereby L0 leakage occur. Hence, a wider black matrix (BM) needs to be provided, resulting in a decreases in a pixel aperture ratio.

### SUMMARY

In one aspect, the present disclosure provides in some embodiments a display substrate, including a substrate, and a first electrode, a second electrode, a plurality of first lines and a plurality of second lines arranged on the substrate. The first lines intersect the second lines to define a plurality of pixel regions, at least one sub-pixel is arranged in each pixel region, and the sub-pixel includes the first electrode and the second electrode. The first line is arranged in a first wiring region, and the second line is arranged in a second wiring region. The first electrode is arranged between the substrate and the second electrode, the second electrode includes a plurality of second electrode members arranged in an array form and arranged in a corresponding pixel region, an orthogonal projection of the second electrode onto the substrate is independent of an orthogonal projection of the first wiring region onto the substrate, and an orthogonal projection of the first electrode onto the substrate overlaps with the orthogonal projection of the first wiring region onto the substrate. The first electrode in at least one of the pixel regions has an aperture structure extending along a first direction, and the first direction is parallel to an extension direction of the first line. In a second direction, an orthogonal projection of the aperture structure onto the substrate is spaced apart from an orthogonal projection of the first line at a first side of the aperture structure onto the substrate by a first distance, the orthogonal projection of the aperture structure onto the substrate is spaced apart from an orthogonal projection of the first line at a second side of the aperture structure onto the substrate by a second distance, the first side is arranged opposite to the second side, and the first direction intersects the second direction.

In a possible embodiment of the present disclosure, the first distance is smaller than the second distance, and a ratio of the first distance to the second distance is greater than or equal to 0.25 and smaller than or equal to 0.5.

In a possible embodiment of the present disclosure, the orthogonal projection of the aperture structure onto the substrate at least partially overlaps with the orthogonal projection of the second electrode onto the substrate.

In a possible embodiment of the present disclosure, the orthogonal projection of the aperture structure onto the substrate does not overlap with the orthogonal projection of the second electrode onto the substrate.

In a possible embodiment of the present disclosure, the orthogonal projection of the aperture structure onto the substrate partially overlaps with an orthogonal projection of at least one second electrode member of the second electrode onto the substrate.

In a possible embodiment of the present disclosure, in the first direction, a length of the aperture structure is smaller than or equal to a length of the second electrode member.

In a possible embodiment of the present disclosure, a pixel includes M second electrode members arranged in a same pixel region, and m aperture structures is formed in a same pixel region, where M is an integer greater than or equal to 3, and m is a positive integer smaller than or equal to M.

In a possible embodiment of the present disclosure, the pixel includes a first one of the second electrode members, a second one of the second electrode members and a third one of the second electrode members, the first one of the second electrode members is arranged in a first sub-pixel region of a same pixel region, the second one of the second electrode members is arranged in a second sub-pixel region of the same pixel region, and the third one of the second electrode members is arranged in a third sub-pixel region of the same pixel region. A first aperture structure, a second aperture structure and a third aperture structure are formed in the same pixel region. The first aperture structure is arranged in the first sub-pixel region, the second aperture structure is arranged in the second sub-pixel region, and the third aperture structure is arranged in the third sub-pixel region.

In a possible embodiment of the present disclosure, the pixel includes a first one of the second electrode members, a second one of the second electrode members and a third one of the second electrode members, the first one of the second electrode members is arranged in a first sub-pixel region of a same pixel region, the second one of the second electrode members is arranged in a second sub-pixel region of the same pixel region, and the third one of the second electrode members is arranged in a third sub-pixel region of the same pixel region. A first aperture structure and a second aperture structure are formed in the same pixel region. The first aperture structure is arranged in the first sub-pixel region and the second aperture structure is arranged in the second sub-pixel region.

In a possible embodiment of the present disclosure, the pixel includes a first one of the second electrode members, a second one of the second electrode members and a third one of the second electrode members, the first one of the second electrode members is arranged in a first sub-pixel region of a same pixel region, the second one of the second electrode members is arranged in a second sub-pixel region of the same pixel region, and the third one of the second electrode member is arranged in a third sub-pixel region of the same pixel region. A first aperture structure and a second aperture structure are formed in the same pixel region. The first aperture structure is arranged in the first sub-pixel region and the second aperture structure is arranged in the third sub-pixel region.

In a possible embodiment of the present disclosure, the pixel includes a first one of the second electrode members, a second one of the second electrode members and a third one of the second electrode members, the first one of the second electrode members is arranged in a first sub-pixel region of a same pixel region, the second one of the second electrode members is arranged in a second sub-pixel region of the same pixel region, and the third one of the second electrode members is arranged in a third sub-pixel region of the same pixel region. A first aperture structure and a second aperture structure are formed in the same pixel region. The first aperture structure is arranged in the second sub-pixel region, and the second aperture structure is arranged in the third sub-pixel region.

In a possible embodiment of the present disclosure, the pixel includes a first one of the second electrode members, a second one of the second electrode members and a third one of the second electrode members, the first one of the second electrode members is arranged in a first sub-pixel region of a same pixel region, the second one of the second electrode members is arranged in a second sub-pixel region of the same pixel region, and the third one of the second electrode members is arranged in a third sub-pixel region of the same pixel region. A first aperture structure is formed in the same pixel region, and the first aperture structure is arranged in the first sub-pixel region, the second sub-pixel region or the third sub-pixel region.

In a possible embodiment of the present disclosure, the second electrode member includes a plurality of second electrode portions extending in the first direction and arranged in the second direction, and a length of the second electrode portion in the second direction is greater than or equal to 1.8 μm and smaller than or equal to 3.5 m.

In a possible embodiment of the present disclosure, a distance between two adjacent second electrode portions in the second electrode member in the second direction is greater than or equal to 2.3 μm and smaller than or equal to 6 m.

In a possible embodiment of the present disclosure, the second electrode portion extends in a substantially same direction as the first line.

In a possible embodiment of the present disclosure, a third line is arranged between two adjacent columns of second electrode members in the second direction, the first electrode includes a plurality of first electrode members arranged in an array form and independent of each other, and the third line is electrically coupled to the first electrode member.

In a possible embodiment of the present disclosure, the second line is arranged between two adjacent columns of second electrode members in the second direction, and the second line is arranged close to the third line.

In a possible embodiment of the present disclosure, a width of the third line is smaller than or equal to a width of the second line in the first direction, and a distance between two adjacent columns of second electrode members in the first direction is greater than or equal to 3 μm and smaller than or equal to 6 m.

In a possible embodiment of the present disclosure, a width of the third line is greater than a width of the second line in the first direction.

In a possible embodiment of the present disclosure, the display substrate further includes a pixel array, a display region and a peripheral region, the pixel array includes the sub-pixels, and the pixel array is arranged in the display region. The display substrate further includes dummy sub-pixels arranged in the peripheral region and immediately adjacent to the display region, and a length of at least a part of the dummy sub-pixels in the first direction is smaller than a length of the sub-pixel in the first direction.

In a possible embodiment of the present disclosure, the first line includes a first end and a second end, the display substrate further includes a plurality of electrostatic discharge blocks arranged on the substrate, the electrostatic discharge blocks are conductive blocks, and each electrostatic discharge block is electrically coupled to the first end or the second end of the first line.

In a possible embodiment of the present disclosure, the electrostatic discharge block is arranged at a same layer, and made of a same material, as the first line.

In a possible embodiment of the present disclosure, a length of the electrostatic discharge block in the second direction is greater than a line width of the first line.

### BRIEF DESCRIPTION OF THE DRAWINGS

FIG. 1 is a schematic view showing the layout of a plurality of second electrode members according to one embodiment of the present disclosure;

FIG. 2 is a schematic view showing the layout of a plurality of first lines according to one embodiment of the present disclosure;

FIG. 3 is a schematic view showing the layout of the plurality of second electrode members according to one embodiment of the present disclosure;

FIG. 4A is a curve diagram of luminous efficiency of a pixel structure varying along with lengths of the aperture structure of the first electrode in a first direction according to one embodiment of the present disclosure;

FIG. 4B is a schematic view showing the luminous efficiency when W is equal to 3.8 μm;

FIG. 4C is a schematic view showing the luminous efficiency when W is equal to 6.8 μm;

FIG. 4D is a schematic view showing the luminous efficiency when W is equal to 9.8 μm;

FIG. 5 is a schematic view showing a display substrate according to one embodiment of the present disclosure;

FIG. 6 is a schematic view showing the layout of a gate metal layer in FIG. 5;

FIG. 7 is a schematic view showing the layout of a source/drain metal layer in FIG. 5;

FIG. 8 is a schematic view showing the layout of a common electrode layer in FIG. 5;

FIG. 9 is a schematic view showing the layout of a pixel electrode layer in FIG. 5;

FIG. 10 is a schematic view showing a situation where the gate metal layer, an active layer, the common electrode layer and the source/drain metal layer in FIG. 5 are laminated one on another;

FIG. 11 is a schematic view showing the layout of the display substrate according to one embodiment of the present disclosure;

FIG. 12A is a schematic view showing the layout of the display substrate according to one embodiment of the present disclosure;

FIG. 12B is a schematic view showing the layout of the display substrate according to one embodiment of the present disclosure;

FIG. 12C is a schematic view showing the layout of the display substrate according to one embodiment of the present disclosure;

FIG. 12D is a sectional view of the display substrate along line A-A′ in FIG. 12C;

FIG. 12E is a schematic view showing the luminous efficiency when W is equal to 3.8 μm;

FIG. 12F is a curve diagram showing the relationship between the luminous efficiency and a width W of the aperture structure;

FIG. 12G is a schematic view showing the luminous efficiency when W is equal to 6.8 μm;

FIG. 12H is a schematic view showing the luminous efficiency when W is equal to 9.8 μm;

FIG. 12I is a curve diagram showing the relationship between the luminous efficiency and a width W1 of a second electrode portion;

FIG. 12J is a schematic view showing the luminous efficiency when the width W1 of the second electrode portion is 1.8 μm;

FIG. 12K is a schematic view showing the luminous efficiency when the width W1 of the second electrode portion is 3 μm;

FIG. 12L is a schematic view showing the preparation of the display substrate according to one embodiment of the present disclosure;

FIG. 13 is a schematic view showing the layout of the display substrate according to one embodiment of the present disclosure;

FIG. 14 is a schematic view showing the layout of the gate metal layer in FIG. 13;

FIG. 15 is a schematic view showing the layout of the source/drain metal layer in FIG. 13;

FIG. 16 is a schematic view showing the layout of the common electrode layer in FIG. 13;

FIG. 17 is a schematic view showing the layout of the pixel electrode layer in FIG. 13;

FIG. 18A is a schematic view showing the layout of a dummy sub-pixel region at an upper left corner of the display substrate;

FIG. 18B is another schematic view showing the layout of the dummy sub-pixel region at the upper left corner of the display substrate;

FIG. 18C is a schematic view showing the layout of the gate metal layer in FIG. 18A;

FIG. 18D is a schematic view showing the layout of a second electrode layer in FIG. 18A;

FIG. 18E is a schematic view showing the layout of a first electrode layer in FIG. 18A;

FIG. 18F is a schematic view showing the layout of the source/drain metal layer in FIG. 18A;

FIG. 19A is a schematic view showing the layout of a part of the dummy sub-pixel region in the display substrate;

FIG. 19B is another schematic view showing the layout of a part of the dummy sub-pixel region in the display substrate;

FIG. 19C is a schematic view showing the layout of the gate metal layer in FIG. 19A;

FIG. 19D is a schematic view showing the layout of the second electrode layer in FIG. 19A;

FIG. 19E is a schematic view showing the layout of the first electrode layer in FIG. 19A; and

FIG. 19F is a schematic view showing the layout of the source/drain metal layer in FIG. 19A.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Such a word as “about”, “approximately” or “similar” involved in the embodiments of the present disclosure relates to a value thereafter or an average value within an acceptable deviation range. The acceptable deviation range is determined in accordance with an error related to the discussed measurement or the measurement of a particular quantity (i.e., a limitation of a measurement system).

Such a word as “parallel”, “vertical” and “equal” involved in the embodiments of the present disclosure relates to a described situation and a situation similar thereto. The similar situation is within an acceptable deviation range, and the acceptable deviation range is determined in accordance with an error related to the discussed measurement or the measurement of a particular quantity (i.e., the limitation of the measurement system). For example, “parallel” includes “exactly parallel” and “approximately parallel”, and the acceptable deviation range of “approximately parallel” includes ±5°. For another example, “vertical” includes “exactly vertical” and “approximately vertical”, and the acceptable deviation range of “approximately vertical” includes ±5°. For yet another example, “equal” includes “exactly equal” and “approximately equal”, and the acceptable deviation range of “approximately equal” includes ±10%.

It should be appreciated that, when a layer or element is arranged on another layer or a substrate, it means that the layer or element is directly arranged on the other layer or the substrate, or there is an intermediate layer therebetween.

The present disclosure will be described hereinafter illustratively with reference to the sectional views and/or planar views. In these drawings, for clarification, a thickness of a layer and an area of a region are enlarged. Hence, any change in a shape caused by the manufacturing technology and/or a manufacturing tolerance may be taken into consideration, and the shape of the region shall not be limited to that shown in the drawings. For example, a regular etching region shown in the drawings is usually curved. In a word, the drawings are for illustrative purposes only, and the shape of the region in the drawings does not intend to reflect an actual shape.

In the embodiments of the present disclosure, such a shape as circular, triangle, rectangle, trapezoid, pentagon or hexagon also includes a nearly geometrical shape, i.e., the shape may include any tiny deformation caused by the tolerance, e.g., a chamfered angle or an arc-like edge.

All transistors adopted in the embodiments of the present disclosure may be TFTs, field effect transistors (FETs) or any other elements having an identical characteristic. In order to differentiate two electrodes other than a gate electrode from each other, one of the two electrodes is called as first electrode and the other is called as second electrode.

In actual use, when the transistor is a TFT or FET, the first electrode may be a drain electrode and the second electrode may be a source electrode, or the first electrode may be a source electrode and the second electrode may be a drain electrode.

The present disclosure provides in some embodiments a display substrate, which includes a substrate, and a first electrode, a second electrode, a plurality of first lines and a plurality of second lines arranged on the substrate. The first lines intersect the second lines to define a plurality of pixel regions, at least one sub-pixel is arranged in each pixel region, and each sub-pixel includes the first electrode and the second electrode. The first line is arranged in a first wiring region, and the second line is arranged in a second wiring region. The first electrode is arranged between the substrate and the second electrode, the second electrode includes a plurality of second electrode members arranged in an array form and arranged in a corresponding pixel region, an orthogonal projection of the second electrode onto the substrate is independent of an orthogonal projection of the first wiring region onto the substrate, and an orthogonal projection of the first electrode onto the substrate overlaps with the orthogonal projection of the first wiring region onto the substrate. The first electrode in at least one of the pixel regions has an aperture structure extending along a first direction, and the first direction is parallel to an extension direction of the first line. In a second direction, an orthogonal projection of the aperture structure onto the substrate is spaced apart from an orthogonal projection of the first line at a first side of the aperture structure onto the substrate by a first distance, the orthogonal projection of the aperture structure onto the substrate is spaced apart from an orthogonal projection of the first line at a second side of the aperture structure onto the substrate by a second distance, the first side is arranged opposite to the second side, and the first direction intersects the second direction.

In at least one embodiment of the present disclosure, the first direction is a horizontal direction or an approximately horizontal direction, and the second direction is a vertical direction.

For example, the first side is an upper side and the second side is a lower side, or the first side is a lower side and the second side is an upper side. Alternatively, when a first line corresponding to a pixel region is taken as a reference, the first side is a side of the aperture structure close to the first line, and the second side is a side of the aperture structure away from the first line. However, the present disclosure is not limited thereto.

In a possible embodiment of the present disclosure, the second direction is a longitudinal direction, and the first direction is substantially parallel to an extension direction of a gate line.

In at least one embodiment of the present disclosure, the first electrode is a common electrode and the second electrode is a pixel electrode. The first line is a gate line and the second line is a data line, or the first line is a data line and the second line is a gate line. A third line is a touch signal line.

In at least one embodiment of the present disclosure, when the sub-pixel includes the first electrode and the second electrode, it means that the sub-pixel includes electrode members of the first electrode and electrode members of the second electrode.

In the related art, for a conventional oxide multi-gate structure, in order to achieve a touch function, a common electrode is divided into blocks in a traditional way and an aperture structure is arranged above a gate line. At this time, a fringing electric field is formed between the gate line and the common electrode, so the deflection of liquid crystals and thereby L0 leakage occur. Hence, a wider black matrix (BM) needs to be provided, resulting in a decreases in a pixel aperture ratio.

In order to solve the above-mentioned problem, in the embodiments of the present disclosure, the orthogonal projection of the aperture structure of the first electrode onto the substrate does not overlap with the orthogonal projection of the first line onto the substrate, so as to prevent the formation of any fringing electric field between the first line (the gate line) and the first electrode (the common electrode), thereby to prevent the occurrence of the L0 leakage caused by the deflection of the liquid crystals.

In a possible embodiment of the present disclosure, the first distance is smaller than the second distance, and a ratio of the first distance to the second distance is greater than or equal to 0.25 and smaller than or equal to 0.5.

In the embodiments of the present disclosure, when the ratio of the first distance to the second distance is set to be greater than or equal to 0.25 and smaller than or equal to 0.5, i.e., when a distance between the aperture structure and the first line arranged at a first side of the aperture structure is set to be smaller than a distance between the aperture structure and the second line arranged at a second side thereof, it is able to improve an aperture ratio.

In at least one embodiment of the present disclosure, the first electrode includes a plurality of first electrode members independent of each other and arranged in an array form, each first electrode member covers a plurality of pixel regions in rows and columns, and a sub-pixel is arranged in each pixel region. The vertically adjacent first electrode members are spaced apart from each other through the aperture structure extending in the first direction, and a common electrode pattern between two laterally adjacent first electrode members is interrupted, so as to separate two columns of first electrode members from each other. However, for the sake of process consistency, at least one aperture structure extending in the first direction may also be formed inside each first electrode member, and the aperture structure has a small lateral width, so it is impossible to separate the first electrode members from each other.

In the related art, the output of small and medium-sized notebooks and vehicle-mounted display screens increases steadily, the technical specifications thereof are gradually stringent, and the demand on in-cell touch gradually increases. In an existing display and display driver integration (TDDI) product, there is a large quantity of source drivers with a relatively high price, so the cost of the TDDI product is high. Based on this, a display substrate in which a pixel electrode is arranged laterally (i.e., an extension direction of the pixel electrode is approximately the same as that of a gate line) is proposed. At this time, the quantity of gate lines is three times that in the existing display product, and the quantity of data lines is ⅓ of that in the existing display product. In this way, in the case that the resolution of the display product remains unchanged, it is able to remarkably reduce the quantity of data lines, thereby to reduce the quantity of source drivers as well as the cost thereof. In addition, a common electrode is separated through providing an appropriate position of a touch signal line and a connection via hole for the touch signal line, and each touch signal line is coupled to a corresponding common electrode block, so as to provide an integrated touch function.

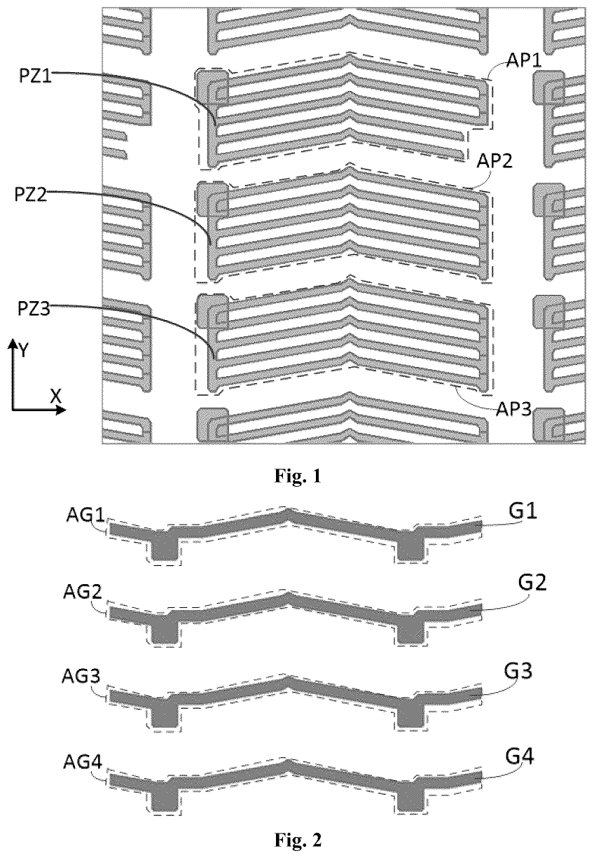

FIG. 1 shows the layout of the plurality of second electrode members.

In FIG. 1, PZ1 represents a first one of the second electrode members, PZ2 represents a second one of the second electrode members, and PZ3 represents a third one of the second electrode members.

FIG. 2 shows the layout of a plurality of first lines. In a possible embodiment of the present disclosure, the first line is a gate line.

In FIG. 2, G1 represents a first gate line, G2 represents a second gate line, G3 represents a third gate line, and G4 represents a fourth gate line. G1 is arranged in a first wiring region AG1, G2 is arranged in a second wiring region AG2, G3 is arranged in a third wiring region AG3, and G4 is arranged in a fourth wiring region AG4.

In a possible embodiment of the present disclosure, the first line is a gate line, and the second electrode member includes a plurality of second electrode portions extending in the first direction.

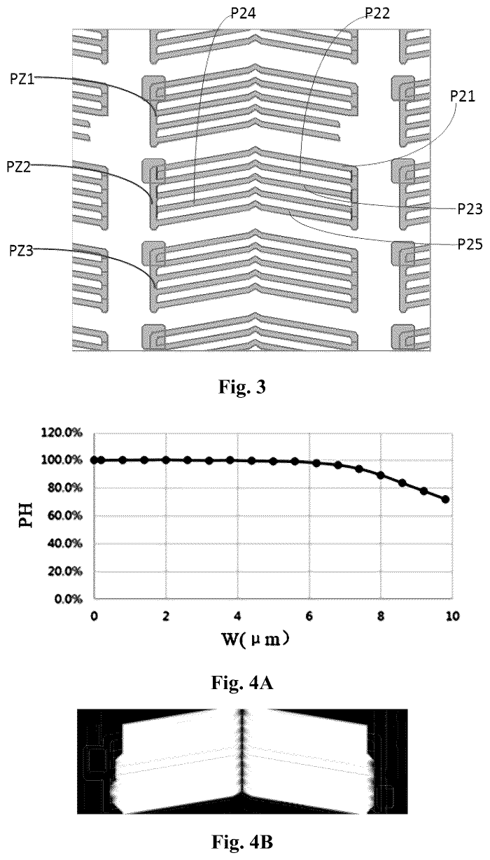

As shown in FIG. 3, on the basis of the plurality of second electrode members in FIG. 1, P21 represents a first pixel electrode corresponding to a second one of the second electrode members PZ2, P22 represents a second pixel electrode corresponding to the second one of the second electrode members PZ2, P23 represents a third pixel electrode corresponding to the second one of the second electrode members PZ2, P24 represents a fourth pixel electrode corresponding to the second one of the second electrode members PZ2, and P25 represents a fifth pixel electrode corresponding to the second one of the second electrode members PZ2. P21, P22, P23, P24 and P25 all extend in the first direction.

In a possible embodiment of the present disclosure, the second electrode is a pixel electrode.

In the drawings, X represents the first direction, Y represents the second direction, and Z represents a third direction. The first direction X is a horizontal direction, the second direction Y is a vertical direction, and the third direction Z is a direction perpendicular to the substrate.

In at least one embodiment of the present disclosure, the orthogonal projection of the aperture structure onto the substrate at least partially overlaps with the orthogonal projection of the second electrode onto the substrate.

During the implementation, the orthogonal projection of the aperture structure onto the substrate at least partially overlaps with the orthogonal projection of the second electrode onto the substrate. In other words, at least one second electrode portion of the second electrode member is arranged above the aperture structure, so as to prevent the occurrence of any interference caused by an electric field from the gate line at L0, thereby to prevent the occurrence of light leakage. At a grayscale level L255, there is no weak zone due to the fringing electric field between the aperture structure and the second electrode member, and the light transmittance is increased by 10% as compared with a conventional design, so it is able to improve the competitiveness of the display product.

In actual use, the orthogonal projection of the aperture structure onto the substrate at least partially, but not limited to, overlaps with the orthogonal projection of the second electrode onto the substrate.

In at least one embodiment of the present disclosure, the orthogonal projection of the aperture structure onto the substrate does not overlap with an orthogonal projection of at least one second electrode member in the second electrode onto the substrate.

During the implementation, no second electrode member is arranged above the aperture structure. At this time, there is a very weak electric field at a hollowed-out region of a second electrode layer, and a weak zone is formed, which is equivalent to single-gate TDDI. The third line is arranged at a display region, so as to block a part of the light.

In at least one embodiment of the present disclosure, the third line is a touch signal line.

During the implementation, the orthogonal projection of the aperture structure onto the substrate partially overlaps with an orthogonal projection of at least one second electrode member in the second electrode onto the substrate.

In at least one embodiment of the present disclosure, when the orthogonal projection of the aperture structure onto the substrate partially overlaps with the orthogonal projection of at least one second electrode member in the second electrode onto the substrate, a length of the aperture structure is smaller than or equal to a length of the second electrode member in the first direction, so the aperture structure is completely covered by the second electrode member in the first direction.

In a possible embodiment of the present disclosure, the length of the aperture structure in the first direction is smaller than or equal to 5.6 m.

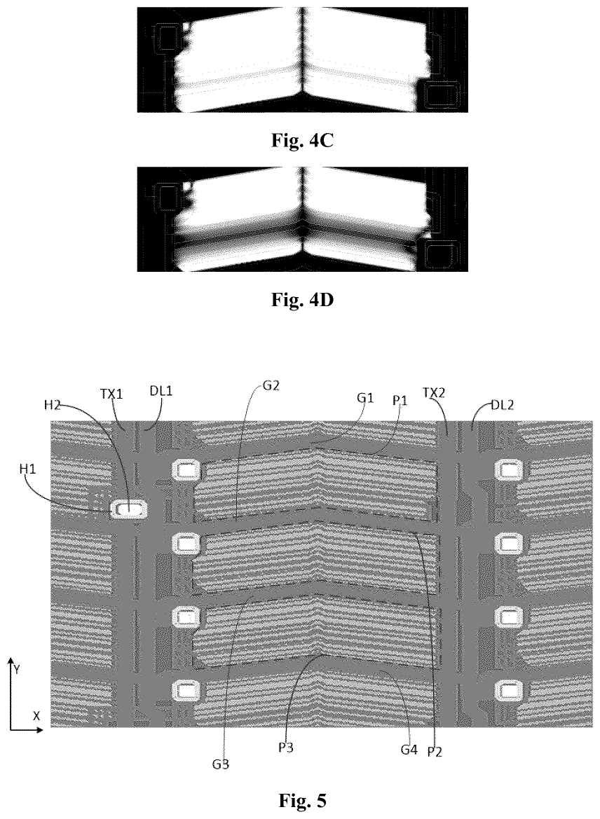

In at least one embodiment of the present disclosure, FIG. 4A shows the luminous efficiency of a pixel structure varying along with the length of the aperture structure in the first direction.

As shown in FIG. 4A, when the length W of the aperture structure in the first direction is smaller than or equal to 5.6 μm, the luminous efficiency changes a little along with an increase in the length W. When the length W is greater than 5.6 μm, the luminous efficiency significantly decreases along with the increase in W, and such a defect as Mura occurs. An appropriate value of W may be set by taking the process feasibility into consideration.

FIG. 4B shows the luminous efficiency when W is equal to 3.8 μm, FIG. 4C shows the luminous efficiency when W is equal to 6.8 μm, and FIG. 4D shows the luminous efficiency when W is equal to 9.8 μm.

In at least one embodiment of the present disclosure, a pixel includes M second electrode members arranged in a same pixel region, and m aperture structures is formed in a same pixel region, where M is an integer greater than or equal to 3, and m is a positive integer smaller than or equal to M.

During the implementation, the pixel includes at least three second electrode members arranged in a same pixel region, and m aperture structures are arranged in the pixel region, where m is smaller than or equal to M.

In a possible embodiment of the present disclosure, the pixel includes a first one of the second electrode members, a second one of the second electrode members and a third one of the second electrode members, the first one of the second electrode members is arranged in a first sub-pixel region of a same pixel region, the second one of the second electrode members is arranged in a second sub-pixel region of the same pixel region, and the third one of the second electrode members is arranged in a third sub-pixel region of the same pixel region. A first aperture structure, a second aperture structure and a third aperture structure are formed in the same pixel region. The first aperture structure is arranged in the first sub-pixel region, the second aperture structure is arranged in the second sub-pixel region, and the third aperture structure is arranged in the third sub-pixel region.

During the implementation, the pixel includes the first one of the second electrode members, the second one of the second electrode members and the third one of the second electrode members, and three aperture structures are in the same pixel region, and each aperture structure corresponds to one sub-pixel region.

In at least one embodiment of the present disclosure, the first line is a gate line, the second line is a data line, the third line is a touch signal line, the first electrode is a common electrode, and the second electrode is a pixel electrode.

As shown in FIG. 5, G1 represents a first gate line, G2 represents a second gate line, G3 represents a third gate line, G4 represents a fourth gate line, TX1 represents a first touch signal line, TX2 represents a second touch signal line, DL1 represents a first data line, DL2 represents a second data line, P1 represents a first sub-pixel region, P2 represents a second sub-pixel region, and P3 represents a third sub-pixel region. P1, P2, P3 are arranged along the vertical direction.

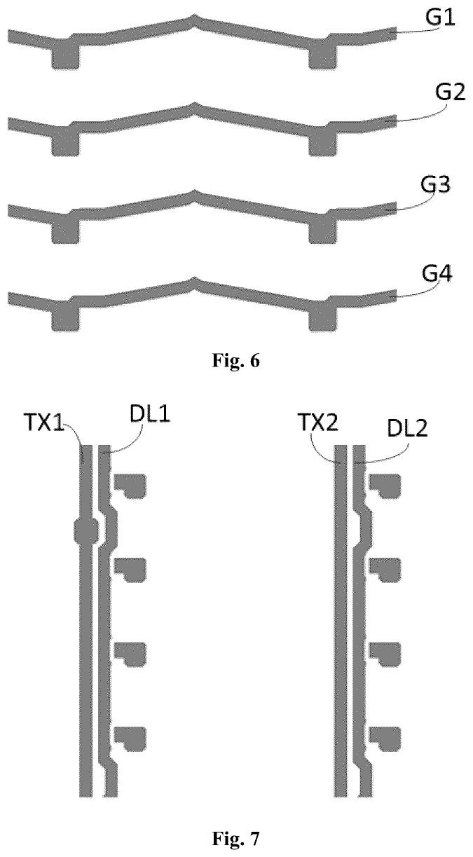

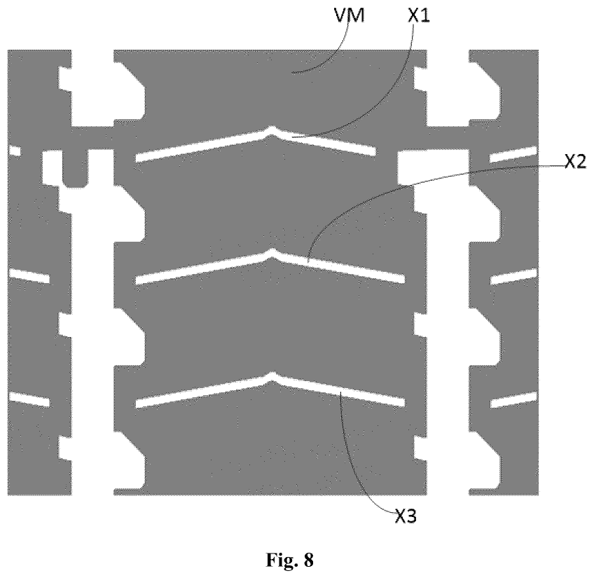

FIG. 6 shows the layout of a gate metal layer in FIG. 5, FIG. 7 shows the layout of a source/drain metal layer in FIG. 5, FIG. 8 shows the layout of a common electrode layer in FIG. 5, and FIG. 9 shows the layout of a pixel electrode layer in FIG. 5.

In FIG. 5, the gate metal layer, an active layer, the source/drain metal layer, the common electrode layer and the pixel electrode layer are laminated one on another in a direction away from the substrate.

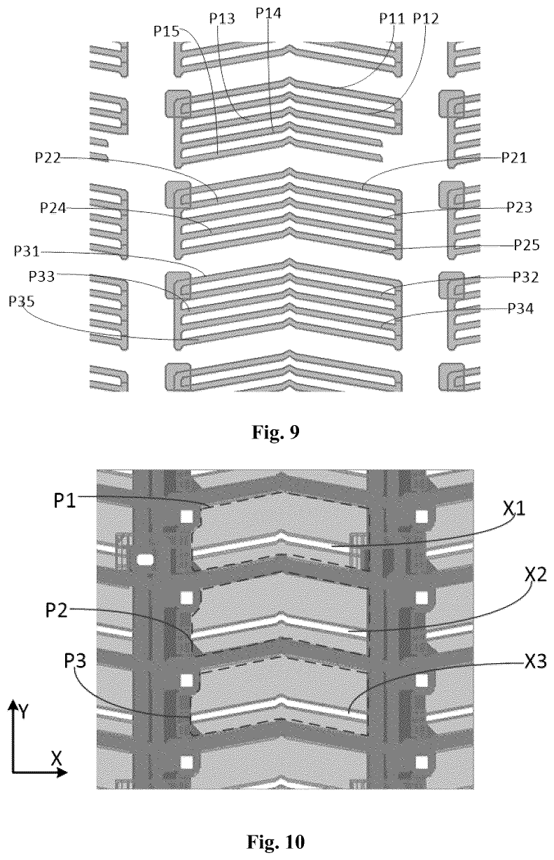

FIG. 10 merely shows the gate metal layer, the active layer, the common electrode layer and the source/drain metal layer in FIG. 5.

In FIG. 6, G1 represents a first gate line, G2 represents a second gate line, G3 represents a third gate line, and G4 represents a fourth gate line.

In FIG. 7, TX1 represents a first touch signal line, TX2 represents a second touch signal line, DL1 represents a first data line, and DL2 represents a second data line.

In FIG. 8, VM represents a common electrode block, X1 represents a first aperture structure, X2 represents a second aperture structure, and X3 represents a third aperture structure.

In FIG. 9, P11 represents a first pixel electrode in the first one of the second electrode members, P12 represents a second pixel electrode in the first one of the second electrode members, P13 represents a third pixel electrode in the first one of the second electrode members, P14 represents a fourth pixel electrode in the first one of the second electrode members, P15 represents a fifth pixel electrode in the first one of the second electrode members, P21 represents a first pixel electrode in the second one of the second electrode members, P22 represents a first pixel electrode in the second one of the second electrode members, P23 represents a third pixel electrode in the second one of the second electrode members, P24 represents a fourth pixel electrode in the second one of the second electrode members, P25 represents a fifth pixel electrode in the second one of the second electrode members, P31 represents a first pixel electrode in the third one of the second electrode members, P32 represents a first pixel electrode in the third one of the second electrode members, P33 represents a third pixel electrode in the third one of the second electrode members, P34 represents a fourth pixel electrode in the third one of the second electrode members, and P35 represents a fifth pixel electrode in the third one of the second electrode members.

As shown in FIGS. 5 to 10, an orthogonal projection of the first aperture structure X1 onto the substrate at least partially overlaps with an orthogonal projection of P11 onto the substrate, an orthogonal projection of the second aperture structure X2 onto the substrate at least partially overlaps with an orthogonal projection of P21 onto the substrate, an orthogonal projection of the third aperture structure X3 onto the substrate at least partially overlaps with an orthogonal projection of P31 onto the substrate. X1 is arranged in the first sub-pixel region, X2 is arranged in the second sub-pixel region, and X3 is arranged in the third sub-pixel region. TX1 and DL1 are arranged adjacent to each other and at a left side of the second electrode member, and TX2 and DL2 are arranged adjacent to each other and at a right side of the second electrode member.

In a possible embodiment of the present disclosure, the pixel includes a first one of the second electrode members, a second one of the second electrode members and a third one of the second electrode members, the first one of the second electrode members is arranged in a first sub-pixel region of a same pixel region, the second one of the second electrode members is arranged in a second sub-pixel region of the same pixel region, and the third one of the second electrode members is arranged in a third sub-pixel region of the same pixel region. A first aperture structure and a second aperture structure are formed in the same pixel region. The first aperture structure is arranged in the first sub-pixel region and the second aperture structure is arranged in the second sub-pixel region.

During the implementation, two aperture structures are arranged in the pixel region. To be specific, the first aperture structure is arranged in the first sub-pixel region and the second aperture structure is arranged in the second sub-pixel region.

In a possible embodiment of the present disclosure, the pixel includes a first one of the second electrode members, a second one of the second electrode members and a third one of the second electrode members, the first one of the second electrode members is arranged in a first sub-pixel region of a same pixel region, the second one of the second electrode members is arranged in a second sub-pixel region of the same pixel region, and the third one of the second electrode member is arranged in a third sub-pixel region of the same pixel region. A first aperture structure and a second aperture structure are formed in the same pixel region. The first aperture structure is arranged in the first sub-pixel region and the second aperture structure is arranged in the third sub-pixel region.

During the implementation, two aperture structures are arranged in the pixel region. To be specific, the first aperture structure is arranged in the first sub-pixel region and the second aperture structure is arranged in the third sub-pixel region.

In a possible embodiment of the present disclosure, the pixel includes a first one of the second electrode members, a second one of the second electrode members and a third one of the second electrode members, the first one of the second electrode members is arranged in a first sub-pixel region of a same pixel region, the second one of the second electrode members is arranged in a second sub-pixel region of the same pixel region, and the third one of the second electrode members is arranged in a third sub-pixel region of the same pixel region. A first aperture structure and a second aperture structure are formed in the same pixel region. The first aperture structure is arranged in the second sub-pixel region, and the second aperture structure is arranged in the third sub-pixel region.

During the implementation, two aperture structures are arranged in the pixel region. To be specific, the first aperture structure is arranged in the second sub-pixel region and the second aperture structure is arranged in the third sub-pixel region.

In a possible embodiment of the present disclosure, the pixel includes a first one of the second electrode members, a second one of the second electrode members and a third one of the second electrode members, the first one of the second electrode members is arranged in a first sub-pixel region of a same pixel region, the second one of the second electrode members is arranged in a second sub-pixel region of the same pixel region, and the third one of the second electrode members is arranged in a third sub-pixel region of the same pixel region. A first aperture structure is formed in the same pixel region, and the first aperture structure is arranged in the first sub-pixel region, the second sub-pixel region or the third sub-pixel region.

During the implementation, one aperture structure is arranged in the pixel region. To be specific, the aperture structure is arranged in the first sub-pixel region, the second sub-pixel region or the third sub-pixel region.

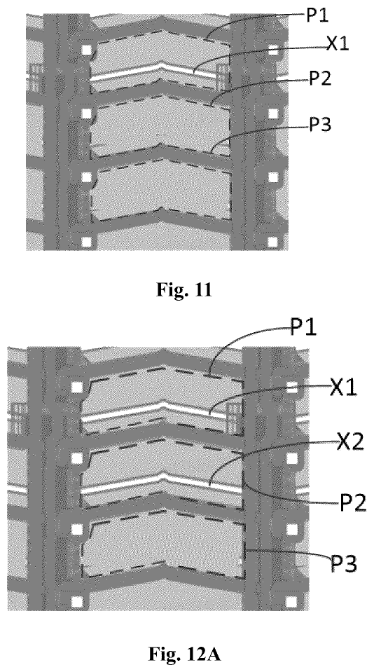

As shown in FIG. 11, the first aperture structure X1 is arranged in the first sub-pixel region P1. In FIG. 11, P2 represents the second sub-pixel region, and P3 represents the third sub-pixel region.

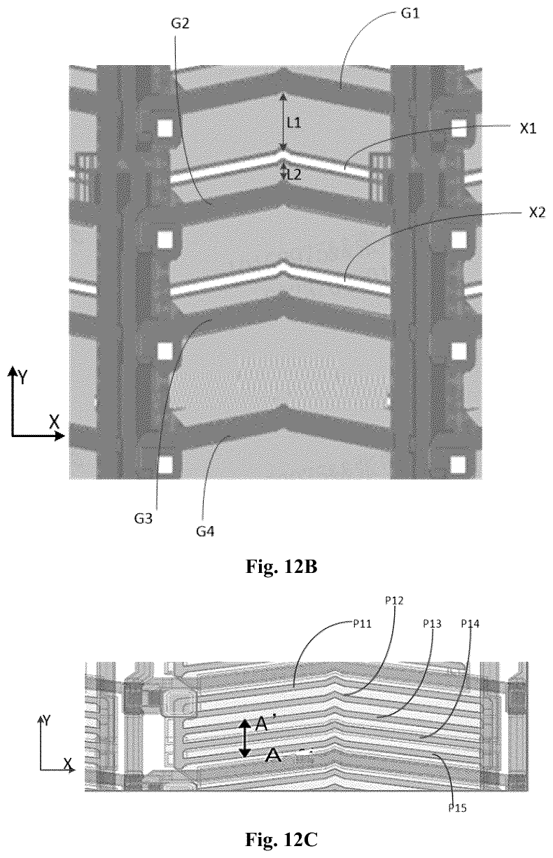

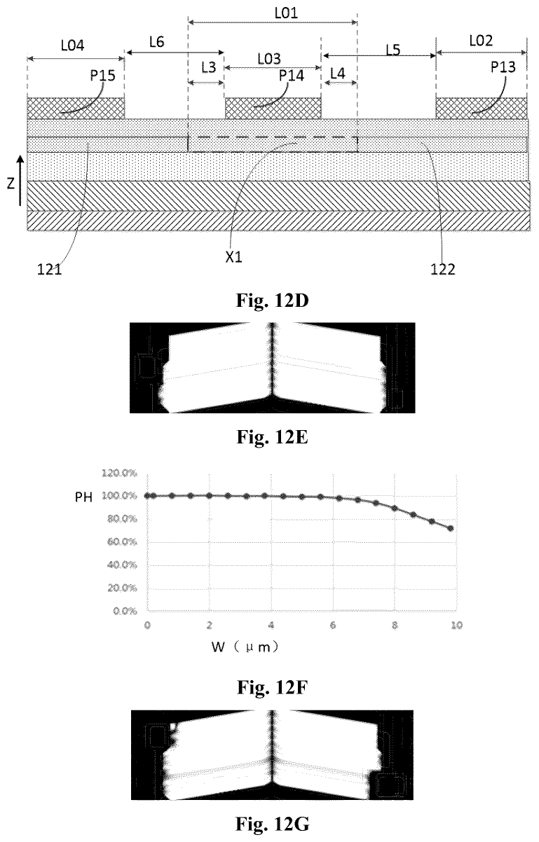

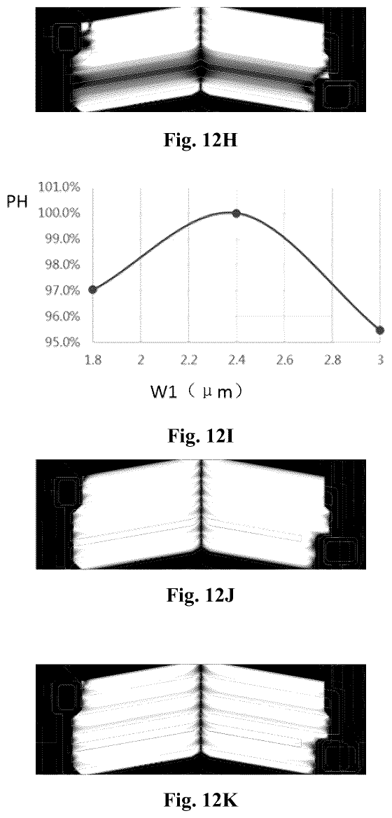

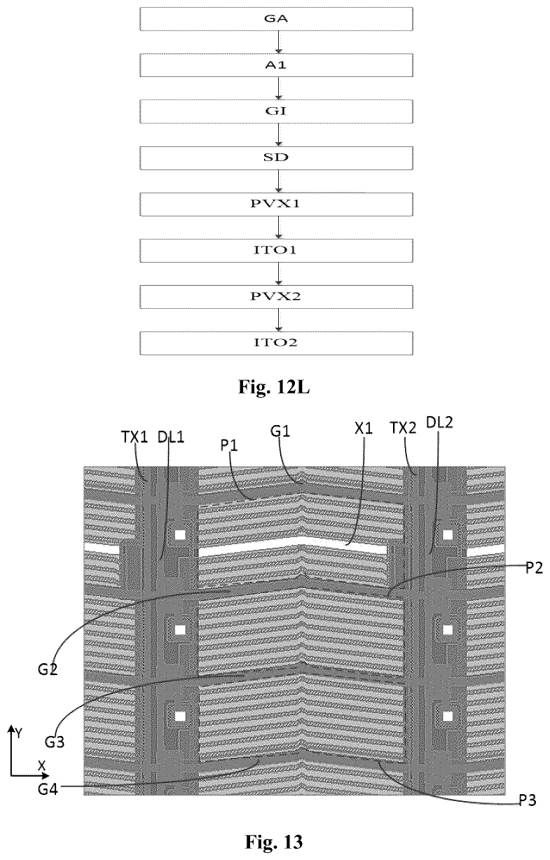

As shown in FIG. 12A, the first aperture structure X1 is arranged in the first sub-pixel region P1, and the second aperture structure is arranged in the second sub-pixel region P2. In FIG. 12A, P2 represents the second sub-pixel region.

As shown in FIG. 12B, an orthogonal projection of the first aperture structure X1 onto the substrate is spaced apart from an orthogonal projection of the first gate line G1 onto the substrate by a first distance L1, the orthogonal projection of the first aperture structure X1 onto the substrate is spaced apart from an orthogonal projection of the second gate line G2 onto the substrate by a second distance L2, and a ratio of L2 to L1 is greater than or equal to 0.25 and smaller than or equal to 0.5, e.g., about 0.3.

In FIG. 12C, P11 represents a first pixel electrode in the first one of the second electrode members, P12 represents a second pixel electrode in the first one of the second electrode members, P13 represents a third pixel electrode in the first one of the second electrode members, P14 represents a fourth pixel electrode in the first one of the second electrode members, and P15 represents a fifth pixel electrode in the first one of the second electrode members. The first aperture structure is arranged below P14.

FIG. 12D is a sectional view of the display substrate along line A-A′ in FIG. 12C.

In FIG. 12D, X1 represents the first aperture structure, 121 represents a first one of first electrode patterns in the first electrode, and 122 represents a second one of first electrode patterns in the first electrode. A width of an orthogonal projection of X1 onto the substrate in the horizontal direction is a first width L01, and L01 is 5 m. An orthogonal projection of P14 onto the substrate is spaced apart from an orthogonal projection of the first one of first electrode patterns 121 onto the substrate by a third distance L3, the orthogonal projection of P14 onto the substrate is spaced apart from an orthogonal projection of the second one of first electrode patterns 122 onto the substrate by a fourth distance L4, and L3 and L4 are each 1.3 m. A width of an orthogonal projection of P13 onto the substrate is a second width L02, a width of the orthogonal projection of P14 onto the substrate is a third width L03, a width of an orthogonal projection of P15 onto the substrate is a fourth width L04, and L02, L03 and L04 are each 2.4 m. The orthogonal projection of P13 onto the substrate is spaced apart from the orthogonal projection of P14 onto the substrate by a fifth distance L5, the orthogonal projection of P14 onto the substrate is spaced apart from the orthogonal projection of P15 onto the substrate by a sixth distance L6, and L5 and L6 are each 4 μm.

In the related art, the common electrode is divided into blocks in a conventional way, i.e., the common electrode above the gate line is interrupted. At this time, a fringing electric field is formed between the gate line and the common electrode, so the deflection of liquid crystals and thereby L0 leakage occur. Hence, a wider black matrix (BM) needs to be provided, resulting in a decreases in a pixel aperture ratio. However, in the embodiments of the present disclosure, the common electrode is divided into blocks at the pixel region, and the pixel electrode is arranged at a position where the common electrode is hollowed out, so as to prevent the occurrence of any interference caused by the electric field from the gate line at L0, thereby to prevent the occurrence of light leakage. In a hollowed-out region at L255, there is no weak zone due to the fringing electric field between the common electrode and the pixel electrode, so the light transmittance of the pixel structure is increased by more than 10% as compared with a conventional design. FIG. 12E shows the luminous efficiency (at this time, W is 3.8 μm). FIG. 12F shows the luminous efficiency of the pixel structure varying along with the width W of the aperture structure (in FIG. 12, the x-axis represents W in unit of μm, and the y-axis represents the luminous efficiency PH). As shown in FIG. 12F, when the width W of the aperture structure is greater than 0 and smaller than or equal to 5.6 μm, the luminous efficiency changes a little along with an increase in W. When the width W of the aperture structure is greater than 5.6 μm, the luminous efficiency significantly decreases along with the increase in W. As shown in FIG. 12G (W is 6.8 μm) and FIG. 12H (W is 9.8 μm), such a defect as Mura occurs. When the width W of the aperture structure remains unchanged, the width W1 of the second electrode portion is adjusted, and the resultant luminous efficiency is shown in FIG. 12I. When W1 is too small, e.g., 1.8 μm, the second electrode portions are spaced apart from each other by a large spacing, and a dark zone occurs, so the luminous efficiency decreases, as shown in FIG. 12J. When W1 is too large, e.g., 3 μm, a dark zone also occurs, so the luminous efficiency decreases, as shown in FIG. 12K. Considering the process feasibility, appropriate values of the width W1 of the second electrode portion, the spacing S between the two adjacent second electrode portions and the width W of the aperture structure may be selected. For example, W1 is greater than or equal to 1.5 μm and smaller than or equal to 3.5 μm, S is greater than or equal to 2.5 μm and smaller than or equal to 5 μm, and W is greater than or equal to 2.5 μm and smaller than or equal to 8 m. FIG. 12L shows the preparation of the display substrate.

In FIG. 12L, GA represents the gate metal layer, A1 represents a semiconductor layer, GI represents a gate insulation layer, SD represents a source/drain metal layer, PVX1 represents a first passivation layer, ITO1 represents a first electrode layer, PVX2 represents a second passivation layer and ITO2 represents a second electrode layer. PVX1 and PVX2 are formed through one-step etching.

In at least one embodiment of the present disclosure, the light transmittance is greater than or equal to 2% and smaller than or equal to 8%, in the case of no brightness enhancement film.

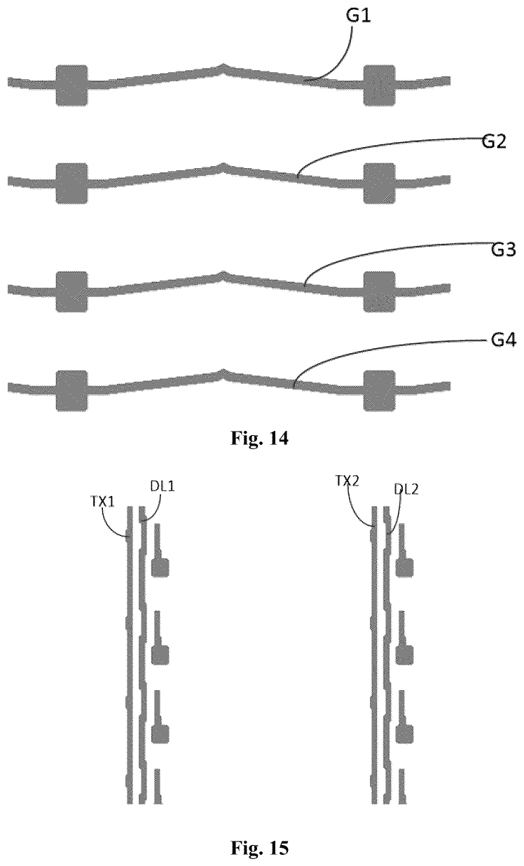

FIG. 13 shows the layout of the display substrate according to one embodiment of the present disclosure.

In at least one embodiment of the present disclosure, the third line is a touch signal line, the second line is a data line, and the first line is a gate line.

In FIG. 13, TX1 represents a first touch signal line, DL1 represents a first data line, TX2 represents a second touch signal line, DL2 represents a second data line, G1 represents a first gate line, G2 represents a second gate line, G3 represents a third gate line, G4 represents a fourth gate line, P1 represents a first sub-pixel region, P2 represents a second sub-pixel region, and P3 represents a third sub-pixel region (P1, P2 and P3 are arranged along the vertical direction).

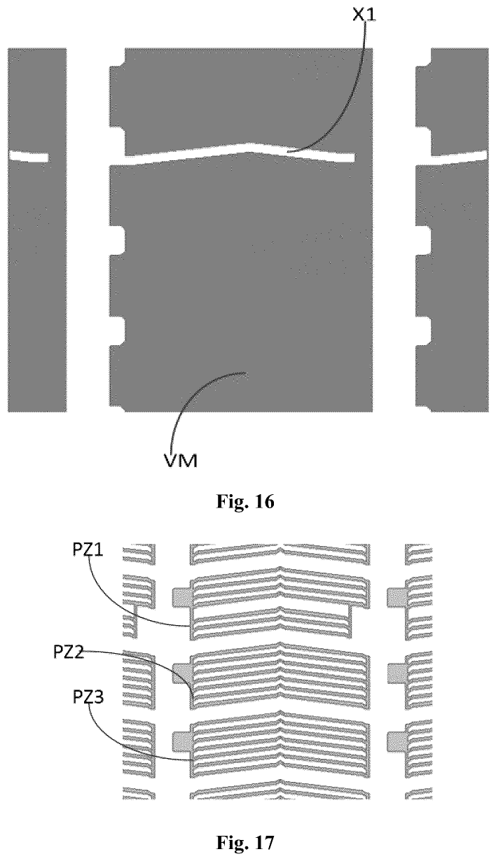

FIG. 14 shows the layout of the gate metal layer in FIG. 13, FIG. 15 shows the layout of the source/drain metal layer in FIG. 13, FIG. 16 shows the layout of the common electrode layer in FIG. 13, and FIG. 17 shows the layout of the pixel electrode layer in FIG. 13.

In FIG. 13, the gate metal layer, the active layer, the source/drain metal layer, the common electrode layer and the pixel electrode layer are laminated one on another in a direction away from the substrate.

In FIG. 13, X1 represents the first aperture structure, and no pixel electrode is arranged at a side of the first aperture structure away from the substrate.

In FIG. 14, G1 represents a first gate line, G2 represents a second gate line, G3 represents a third gate line, and G4 represents a fourth gate line.

In FIG. 15, TX1 represents a first touch signal line, DL1 represents a first data line, TX2 represents a second touch signal line, and DL2 represents a second data line.

In FIG. 16, VM represents a common electrode member, and X1 represents a first aperture structure.

In FIG. 17, PZ1 represents a first one of the second electrode members, PZ2 represents a second one of the second electrode members, PZ3 represents a third one of the second electrode members, and PZ4 represents a fourth one of the second electrode members.

In at least one embodiment of the present disclosure, the second electrode member includes a plurality of second electrode portions extending in the first direction and arranged in the second direction. A length of the second electrode portion in the second direction is greater than or equal to 1.8 μm and smaller than or equal to 3.5 m.

During the implementation, an extension direction of the second electrode portion is substantially the same as an extension direction of the gate line, and the length of the second electrode portion in the vertical direction is greater than or equal to 1.8 μm and smaller than or equal to 3.5 μm. However, the present disclosure is not limited thereto.

In a possible embodiment of the present disclosure, the second direction is a vertical direction.

In the embodiments of the present disclosure, when the extension direction of the second electrode portion is substantially the same as the extension direction of the gate line, the extension direction of the second electrode portion is the same as the extension direction of the gate line, or the extension direction of the second electrode portion is angled relative to the extension direction of the gate line by an angle smaller than 5°. However, the present disclosure is not limited thereto.

In a possible embodiment of the present disclosure, a distance between two adjacent second electrode portions in the second electrode member in the second direction is greater than or equal to 2.3 μm and smaller than or equal to 6 μm.

During the implementation, the distance between two adjacent second electrode portions in the second electrode member in the second direction is, but not limited to, greater than or equal to 2.3 μm and smaller than or equal to 6 μm.

In at least one embodiment of the present disclosure, the extension direction of the second electrode portion is substantially the same as the extension direction of the first line.

In a possible embodiment of the present disclosure, the first line is a gate line.

In at least one embodiment of the present disclosure, a third line is arranged between two adjacent columns of second electrode members in the second direction, the third line is electrically coupled to the first electrode member, and the first electrode member is reused as a touch electrode block. Whether the first electrode member is touched is determined in accordance with a signal on the touch signal line.

In a possible embodiment of the present disclosure, the third line is a touch signal line.

In at least one embodiment of the present disclosure, the second line is arranged between two adjacent columns of second electrode members in the second direction, and the second line is arranged close to the third line.

In a possible embodiment of the present disclosure, the second line is a data line and the third line is a touch signal line.

During the implementation, a distance between the data line and the adjacent touch signal line is greater than or equal to 3 μm and smaller than or equal to 6 μm, e.g., 4.5 μm.

In at least one embodiment of the present disclosure, the distance between the data line and the adjacent touch signal line depends on a load of the data line. When the distance is too large, the aperture ratio may be adversely affected. When the distance is too small, the load of the data line increases, or a short circuit occurs due to metal residues.

During the implementation, the sub-pixel includes a pixel electrode and a switching transistor. A gate electrode of the switching transistor is electrically coupled to the gate line, a source electrode of the switching transistor is electrically coupled to the data line, and a drain electrode of the switching transistor is electrically coupled to the pixel electrode. A channel width of the switching transistor is, but not limited to, 6 μm, and a channel length of the switching transistor is, but not limited to, 4 μm. A width-to-length ratio of a channel of the switching transistor is determined in accordance with the aperture ratio and a charging rate.

In a possible embodiment of the present disclosure, a width of the touch signal line in the first direction is greater than or equal to 3 μm and smaller than or equal to 4 μm, and a width of the data line in the first direction is greater than or equal to 3 μm and smaller than or equal to 5 μm, and a distance between two adjacent columns of second electrode members in the first direction is greater than or equal to 3 μm and smaller than or equal to 6 μm.

During the implementation, the line width of the touch signal line is greater than or equal to 3 μm and smaller than or equal to 4 μm, e.g., 4 μm, and the line width of the data line is greater than or equal to 3 μm and smaller than or equal to 5 μm, e.g., 3.5 μm.

In at least one embodiment of the present disclosure, a width of the gate line in the vertical direction is, but not limited to, greater than or equal to 3.5 μm and smaller than or equal to 7 μm, and a width of the gate line in the vertical direction is, but not limited to, 3.5 μm.

In at least one embodiment of the present disclosure, a width of the third line is greater than a width of the second line along the first direction. The third line is a touch signal line, and the second line is a data line.

In FIG. 5, H1 represents a first via hole and H2 represents a second via hole. The first via hole H1 penetrates through an organic film, and the source electrode of the switching transistor is electrically coupled to the pixel electrode through the first via hole H1. The second via hole H2 penetrates through the passivation layer and is arranged inside the first via hole H1, and the touch signal line is electrically coupled to the common electrode through the second via hole H2.

In at least one embodiment of the present disclosure, a length of an edge of an orthogonal projection of the first via hole H1 onto the substrate is, but not limited to, greater than or equal to 7 μm and smaller than or equal to 10 μm, and a length of an edge of an orthogonal projection of the second via hole H2 onto the substrate is, but limited to, greater than or equal to 4 μm and smaller than or equal to 8 m.

During the implementation, a first passivation layer and an organic film layer are laminated one on another between the source/drain metal layer and the common electrode layer, a second passivation layer is arranged between the common electrode layer and the pixel electrode layer, and the organic film layer is arranged between the first passivation layer and the common electrode layer.

In at least one embodiment of the present disclosure, the display substrate includes a pixel array, a display region and a peripheral region, the pixel array includes the sub-pixels, and the pixel array is arranged in the display region. The display substrate further includes dummy sub-pixels arranged in the peripheral region and immediately adjacent to the display region, and a length of at least a part of the dummy sub-pixels in the first direction is smaller than a length of the sub-pixel in the first direction.

During the implementation, the dummy sub-pixels are arranged in the peripheral region and immediately adjacent to the display region, and the length of at least a part of the dummy sub-pixels in the horizontal direction is smaller than the length of the sub-pixel in the horizontal direction.

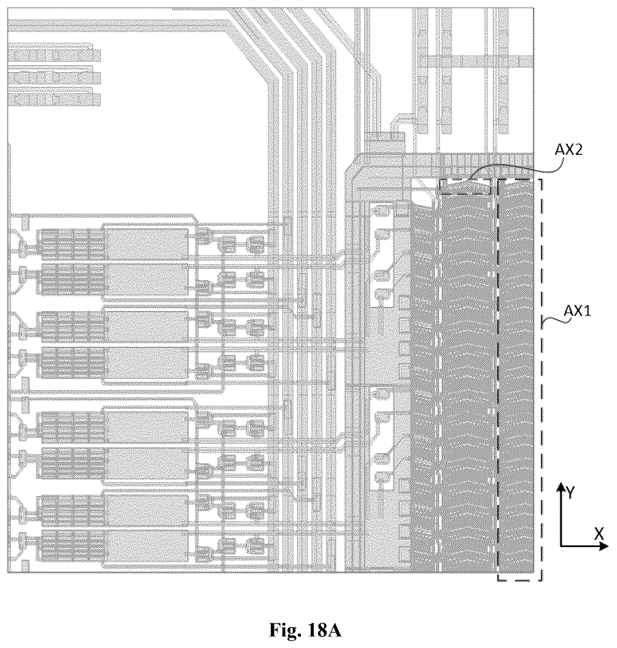

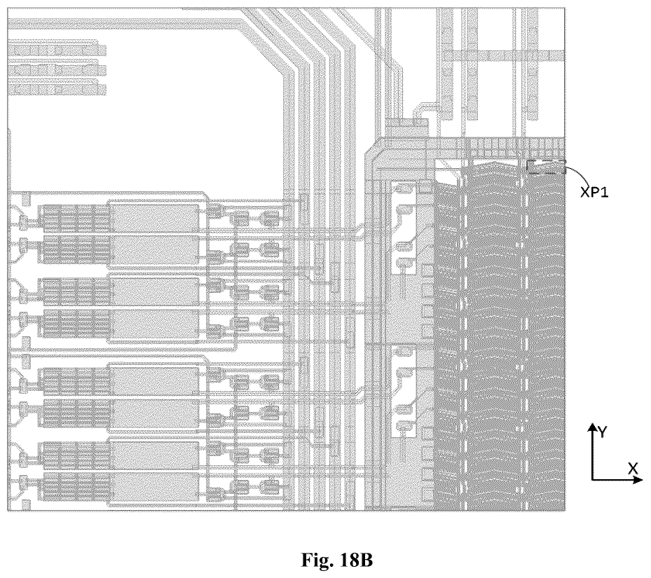

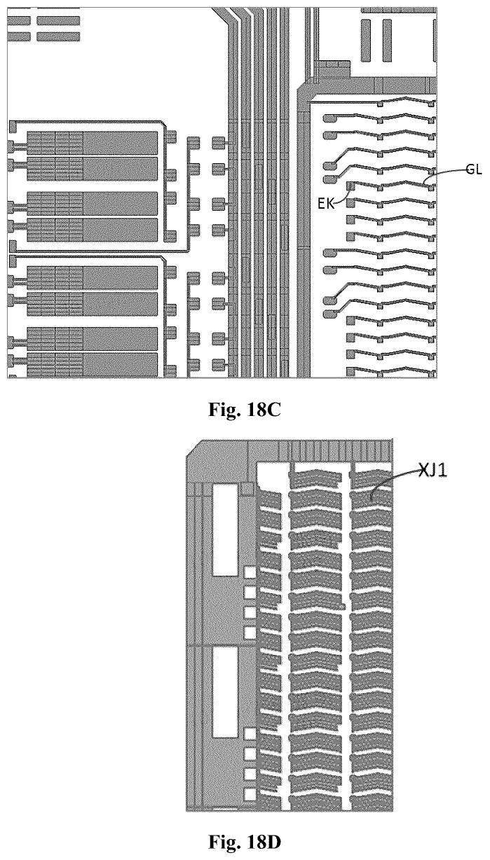

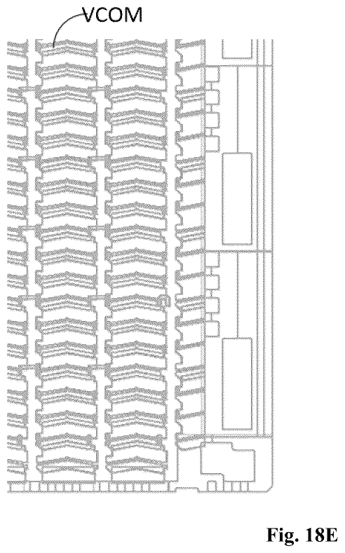

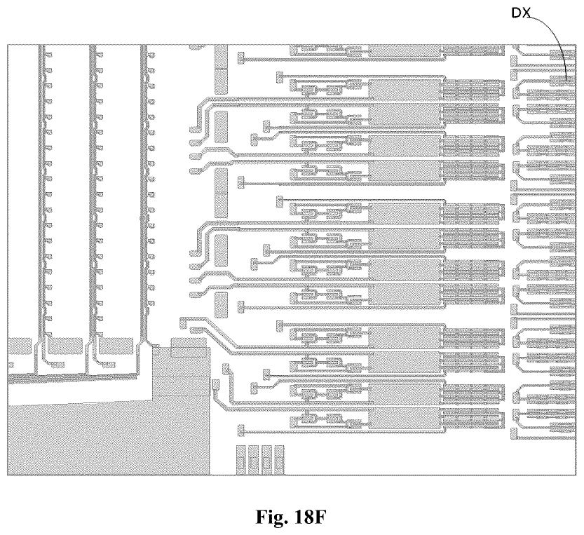

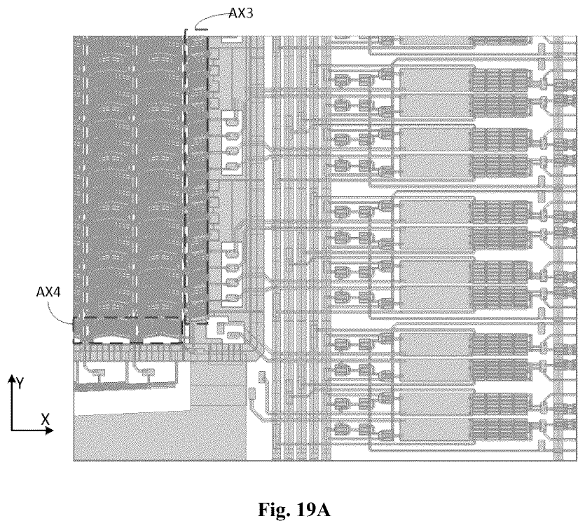

FIG. 18A shows the layout of a dummy sub-pixel region at an upper left corner of the display substrate. In FIG. 18A, AX1 represents a first dummy sub-pixel region, and AX2 represents a second dummy sub-pixel region.

In at least one embodiment of the present disclosure, the length of the dummy sub-pixel in the first dummy sub-pixel region AX1 in the first direction is smaller than the length of the sub-pixel in the first direction, and the length of the dummy sub-pixel in the second dummy sub-pixel region AX2 in the first direction is equal to the length of the sub-pixel in the first direction.

In FIG. 18B, XP1 represents a first dummy sub-pixel. As shown in FIG. 18B, the length of the first dummy sub-pixel XP1 in the first direction is smaller than the length of the sub-pixel in the first direction.

FIG. 18C shows the layout of the gate metal layer in FIG. 18A, and FIG. 18D shows the layout of the second electrode layer in FIG. 18A. In FIG. 18C, GL represents a gate line, and EK represents an electrostatic discharge block. In FIG. 18D, XJ1 represents a first dummy pixel electrode.

FIG. 18E shows the layout of the first electrode layer in FIG. 18A. In FIG. 18E, VCOM represents the common electrode.

FIG. 18F shows the layout of the source/drain metal layer in FIG. 18A. In FIG. 18F, DX represents a conductive pattern.

In a possible embodiment of the present disclosure, the first line includes a first end and a second end, the display substrate further includes a plurality of electrostatic discharge blocks arranged on the substrate, the electrostatic discharge blocks are conductive blocks, and each electrostatic discharge block is electrically coupled to the first end or the second end of the first line.

In a possible embodiment of the present disclosure, the first line is a gate line.

As shown in FIG. 18C, a left end of the gate line GL is electrically coupled to the electrostatic discharge block EK, which is a conductive block.

In a possible embodiment of the present disclosure, the electrostatic discharge block is arranged at a same layer, and made of a same material, as the first line.

As shown in FIG. 18C, the electrostatic discharge block EK is arranged at a same layer, and made of a same material, as the gate line GL.

In at least one embodiment of the present disclosure, a length of the electrostatic discharge block in the second direction is greater than the line width of the first line.

During the implementation, the length of the electrostatic discharge block EK in the vertical direction is greater than the line width of the gate line GL, so as to prevent the electric discharge at an end of the gate line. For example, the line width of the gate line is 3.5 μm, an orthogonal projection of the electrostatic discharge block EK onto the substrate is of a square-like shape with a side length of 18 μm.

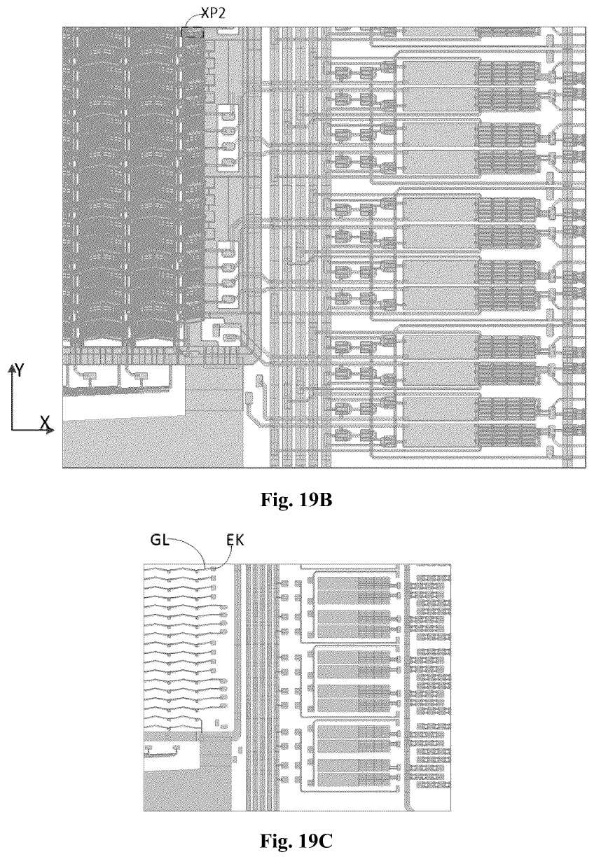

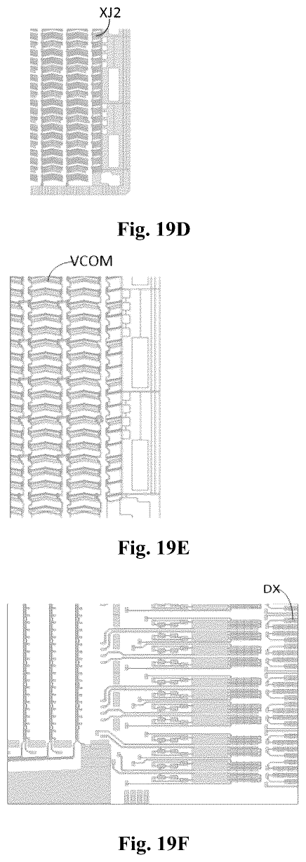

FIG. 19A shows the layout of a part of dummy sub-pixel regions in the display substrate. In FIG. 19A, AX3 represents a third dummy sub-pixel region, and AX4 represents a fourth dummy sub-pixel region.

In at least one embodiment of the present disclosure, a length of the dummy sub-pixel in the third dummy sub-pixel region AX3 in the first direction is, but not limited to, smaller than the length of the sub-pixel in the first direction, and a length of the dummy sub-pixel in the fourth dummy sub-pixel region AX4 in the first direction is, but not limited to, equal to the length of the sub-pixel in the first direction.

In FIG. 19B, XP2 represents the second dummy sub-pixel. As shown in FIG. 19B, a length of the second dummy sub-pixel XP2 in the first direction is smaller than the length of the sub-pixel in the first direction.

FIG. 19C shows the layout of the gate metal layer in FIG. 19A, and FIG. 19D shows the layout of the second electrode layer in FIG. 19A. In FIG. 19C, GL represents a gate line, and EK represents an electrostatic discharge block. In FIG. 19D, XJ2 represents a second dummy pixel electrode.

FIG. 19E shows the layout of the first electrode layer in FIG. 19A. In FIG. 19E, VCOM represents the common electrode.

FIG. 19F shows the layout of the source/drain metal layer in FIG. 19A. In FIG. 19F, DX represents the conductive pattern.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A display substrate, comprising a substrate, and a first electrode, a second electrode, a plurality of first lines and a plurality of second lines arranged on the substrate, wherein the first lines intersect the second lines to define a plurality of pixel regions, at least one sub-pixel is arranged in each pixel region, and the sub-pixel comprises the first electrode and the second electrode;
the first line is arranged in a first wiring region, and the second line is arranged in a second wiring region;
the first electrode is arranged between the substrate and the second electrode, the second electrode comprises a plurality of second electrode members arranged in an array form and arranged in a corresponding pixel region, an orthogonal projection of the second electrode onto the substrate is independent of an orthogonal projection of the first wiring region onto the substrate, and an orthogonal projection of the first electrode onto the substrate overlaps with the orthogonal projection of the first wiring region onto the substrate;
the first electrode in at least one of the pixel regions has an aperture structure extending along a first direction, and the first direction is parallel to an extension direction of the first line; and
in a second direction, an orthogonal projection of the aperture structure onto the substrate is spaced apart from an orthogonal projection of the first line at a first side of the aperture structure onto the substrate by a first distance, the orthogonal projection of the aperture structure onto the substrate is spaced apart from an orthogonal projection of the first line at a second side of the aperture structure onto the substrate by a second distance, the first side is arranged opposite to the second side, and the first direction intersects the second direction.

2. The display substrate according to claim 1, wherein the first distance is smaller than the second distance, and a ratio of the first distance to the second distance is greater than or equal to 0.25 and smaller than or equal to 0.5.

3. The display substrate according to claim 1, wherein the orthogonal projection of the aperture structure onto the substrate at least partially overlaps with the orthogonal projection of the second electrode onto the substrate; or
wherein the orthogonal projection of the aperture structure onto the substrate does not overlap with the orthogonal projection of the second electrode onto the substrate.

4. (canceled)

5. The display substrate according to claim 1, wherein the orthogonal projection of the aperture structure onto the substrate partially overlaps with an orthogonal projection of at least one second electrode member of the second electrode onto the substrate.

6. The display substrate according to claim 1, wherein a length of the aperture structure is smaller than or equal to a length of the second electrode member in the first direction.

7. The display substrate according to claim 1, wherein a pixel comprises M second electrode members arranged in a same pixel region, and m aperture structures is formed in a same pixel region, where M is an integer greater than or equal to 3, and in is a positive integer smaller than or equal to M.

8. The display substrate according to claim 7, wherein the pixel comprises a first one of the second electrode members, a second one of the second electrode members and a third one of the second electrode members, the first one of the second electrode members is arranged in a first sub-pixel region of a same pixel region, the second one of the second electrode members is arranged in a second sub-pixel region of the same pixel region, and the third one of the second electrode members is arranged in a third sub-pixel region of the same pixel region;
a first aperture structure, a second aperture structure and a third aperture structure are formed in the same pixel region; and
the first aperture structure is arranged in the first sub-pixel region, the second aperture structure is arranged in the second sub-pixel region, and the third aperture structure is arranged in the third sub-pixel region.

9. The display substrate according to claim 7, wherein the pixel comprises a first one of the second electrode members, a second one of the second electrode members and a third one of the second electrode members, the first one of the second electrode members is arranged in a first sub-pixel region of a same pixel region, the second one of the second electrode members is arranged in a second sub-pixel region of the same pixel region, and the third one of the second electrode members is arranged in a third sub-pixel region of the same pixel region;
a first aperture structure and a second aperture structure are formed in the same pixel region; and
the first aperture structure is arranged in the first sub-pixel region and the second aperture structure is arranged in the second sub-pixel region.

10. The display substrate according to claim 7, wherein the pixel comprises a first one of the second electrode members, a second one of the second electrode members and a third one of the second electrode members, the first one of the second electrode members is arranged in a first sub-pixel region of a same pixel region, the second one of the second electrode members is arranged in a second sub-pixel region of the same pixel region, and the third one of the second electrode member is arranged in a third sub-pixel region of the same pixel region;
a first aperture structure and a second aperture structure are formed in the same pixel region; and
the first aperture structure is arranged in the first sub-pixel region and the second aperture structure is arranged in the third sub-pixel region.

11. The display substrate according to claim 7, wherein the pixel comprises a first one of the second electrode members, a second one of the second electrode members and a third one of the second electrode members, the first one of the second electrode members is arranged in a first sub-pixel region of a same pixel region, the second one of the second electrode members is arranged in a second sub-pixel region of the same pixel region, and the third one of the second electrode members is arranged in a third sub-pixel region of the same pixel region;
a first aperture structure and a second aperture structure are formed in the same pixel region; and
the first aperture structure is arranged in the second sub-pixel region, and the second aperture structure is arranged in the third sub-pixel region.

12. The display substrate according to claim 7, wherein the pixel comprises a first one of the second electrode members, a second one of the second electrode members and a third one of the second electrode members, the first one of the second electrode members is arranged in a first sub-pixel region of a same pixel region, the second one of the second electrode members is arranged in a second sub-pixel region of the same pixel region, and the third one of the second electrode members is arranged in a third sub-pixel region of the same pixel region; and
a first aperture structure is formed in the same pixel region, and the first aperture structure is arranged in the first sub-pixel region, the second sub-pixel region or the third sub-pixel region.

13. The display substrate according to claim 1, wherein the second electrode member comprises a plurality of second electrode portions extending in the first direction and arranged in the second direction, and a length of the second electrode portion in the second direction is greater than or equal to 1.8 μm and smaller than or equal to 3.5 μm.

14. The display substrate according to claim 13, wherein a distance between two adjacent second electrode portions in the second electrode member in the second direction is greater than or equal to 2.3 μm and smaller than or equal to 6 μm; and/or
wherein the second electrode portion extends in a substantially same direction as the first line.

15. (canceled)

16. The display substrate according to claim 1, wherein a third line is arranged between two adjacent columns of second electrode members in the second direction, the first electrode comprises a plurality of first electrode members arranged in an array form and independent of each other, and the third line is electrically coupled to the first electrode member.

17. The display substrate according to claim 16, wherein the second line is arranged between two adjacent columns of second electrode members in the second direction, and the second line is arranged close to the third line.

18. The display substrate according to claim 17, wherein a width of the third line is smaller than or equal to a width of the second line in the first direction, and a distance between two adjacent columns of second electrode members in the first direction is greater than or equal to 3 μm and smaller than or equal to 6 μm.

19. The display substrate according to claim 17, wherein a width of the third line is greater than a width of the second line in the first direction.

20. The display substrate according to claim 1, further comprising a pixel array, a display region and a peripheral region, wherein the pixel array comprises the sub-pixels, and the pixel array is arranged in the display region,
wherein the display substrate further comprises dummy sub-pixels arranged in the peripheral region and immediately adjacent to the display region, and a length of at least a part of the dummy sub-pixels in the first direction is smaller than a length of the sub-pixel in the first direction.

21. The display substrate according to claim 1, wherein the first line comprises a first end and a second end, the display substrate further comprises a plurality of electrostatic discharge blocks arranged on the substrate, the electrostatic discharge blocks are conductive blocks, and each electrostatic discharge block is electrically coupled to the first end or the second end of the first line.

22. The display substrate according to claim 21, wherein the electrostatic discharge block is arranged at a same layer, and made of a same material, as the first line; and/or
wherein a length of the electrostatic discharge block in the second direction is greater than a line width of the first line.

23. (canceled)
